(19) United States
(12) Patent Application Publication
(10) Pub. No.: US 2020/0269137 A1
(43) Pub. Date: Aug. 27, 2020

(54) INFORMATION PROCESSING APPARATUS, METHOD AND MEDIUM

(71) Applicant: SQUARE ENIX CO., LTD., Tokyo (JP)

(72) Inventors: Toshiyuki KAJIWARA, Tokyo (JP); Kazuo HORIE, Tokyo (JP); Moriaki OSHIRO, Tokyo (JP); Toshifumi NABESHIMA, Tokyo (JP)

(73) Assignee: SQUARE ENIX CO., LTD., Tokyo (JP)

(21) Appl. No.: 16/800,888

(22) Filed: Feb. 25, 2020

(30) Foreign Application Priority Data
Feb. 26, 2019 (JP) 2019033135

(51) Int. Cl. A63F 13/58

(52) U.S. Cl. CPC A63F 13/58

(57) ABSTRACT

An information processing apparatus includes a game processing unit that processes the game including movement of the player character in the virtual field and a difficulty level management unit that manages a difficulty level of game play in each of the plurality of areas in the virtual field, wherein upon a predetermined event in accordance with a user operation occurs in the virtual field, the difficulty level management unit lowers the difficulty level set for a peripheral area near an event occurrence area including an occurrence point of the predetermined event.

### CROSS-REFERENCE TO RELATED APPLICATION

This application is based upon and claims the benefit of priority of the prior Japanese Patent Application No. JP2019-033135, filed on Feb. 26, 2019, the entire contents of which are incorporated herein by reference.

### FIELD

The present invention relates to a technique for controlling a difficulty level of a game.

### BACKGROUND

There has conventionally been proposed a technique used in a game including movement of a player character in a virtual field. In this technique, when an event in the game, such as causing the player character to make a noise, is generated by a user operation, an enemy character is moved closer to the player character (see Non Patent Literature 1: “COMBAT>MORE>Use the environment”, “Tomb Raider|SQUARE ENIX_files” Square Enix Co., Ltd., http://www.tombraider.jp/top.html; and Non Patent Literature 2: “METAL GEAR 25th ANNIVERSARY “The Truth behind METAL GEAR SOLID”” Konami Digital Entertainment Co., Ltd., https://www.konami.com/mg/archive/mg25th/truth/).

### SUMMARY

There is a conventional technique used in a game including movement of a player character in a virtual field. In this technique, when the player character makes a noise, an enemy character finds the player character, or a battle against the enemy character is started, another enemy character in the vicinity is moved toward the location of the player character.

However, the conventional technique is such that the enemy character is moved to the vicinity of the player character or simply that a difficulty level of the game is heightened when a user fails in the game play, and not such that the user can strategically control a difficulty level of the game set for an area in the virtual field.

An object of at least one of embodiments of the present invention is to solve the above problem and allow the user to control a difficulty level of each area included in a virtual field in a game including movement of a player character in the virtual field.

An aspect of the present disclosure is to provide a game processing program that causes a computer to function as: game processing means that processes a game including movement of a player character in a virtual field in which a plurality of areas are set in accordance with a user operation; and difficulty level management means that manages a difficulty level of game play by the user in each of the plurality of areas, wherein, upon a predetermined event in accordance with the user operation occurs in the virtual field, the difficulty level management means lowers the difficulty level set for a peripheral area near an event occurrence area including an occurrence point of the predetermined event among the plurality of areas.

The present disclosure can be understood as a method executed by an information processing apparatus, an information processing system, and a computer or as a program to be executed by a computer. In addition, the present disclosure can also be understood as a recording medium on which such a program is recorded so as to be readable by a computer, another apparatus, a machine, or the like. The recording medium that is readable by a computer, etc. refers to a recording medium that accumulates information such as data and a program electrically, magnetically, optically, mechanically, or chemically so as to be readable by a computer, etc.

According to each embodiment of the present application, one or more problems are solved.

### BRIEF DESCRIPTION OF THE DRAWINGS

FIG. 1 schematically illustrates a configuration of an information processing system corresponding to at least one of embodiments of the present invention;

FIG. 2 schematically illustrates a functional configuration of an information processing apparatus corresponding to at least one of embodiments of the present invention;

FIG. 3 schematically illustrates a game screen displayed on a display area of an output device in at least one of embodiments of the present invention;

FIG. 4 is a flowchart illustrating a flow of difficulty level management processing corresponding to at least one of embodiments of the present invention;

FIG. 5 is a flowchart illustrating a flow of object control processing corresponding to at least one of embodiments of the present invention;

FIG. 6 schematically illustrates a game screen in a case where a difficulty level of each area has been changed in accordance with an event that has occurred, the game screen corresponding to at least one of embodiments of the present invention;

FIG. 7 is a flowchart illustrating a flow of difficulty level management processing corresponding to at least one of embodiments of the present invention; and

FIG. 8 is a flowchart illustrating a flow of object control processing corresponding to at least one of embodiments of the present invention.

### DESCRIPTION OF EMBODIMENTS

Hereinafter, embodiments of the present disclosure will be described with reference to the drawings. The embodiments described below merely represent examples of implementing the present disclosure and are not intended to limit the present disclosure to the specific configurations described below. When implementing the present disclosure, a specific configuration may be adopted as appropriate in accordance with an embodiment.

### First Embodiment

### Configuration of Apparatus

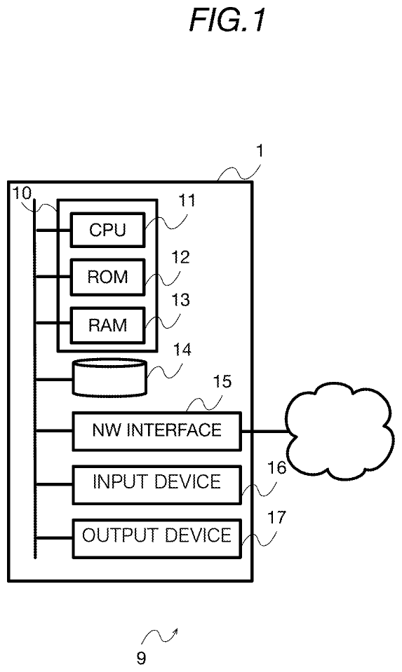

FIG. 1 schematically illustrates a configuration of an information processing system 9 according to the present embodiment. The information processing system 9 according to the present embodiment has an information processing apparatus 1 connected to a network such as the Internet. The information processing apparatus 1 is a game apparatus, etc. used by a user. Various types of apparatuses, such as a smartphone, a portable game device, a stationary game device, or a wearable electric apparatus, can be used as the game apparatus, and the type thereof is not limited. The user can play a game by causing this information processing apparatus 1 to execute game processing based on a game processing program.

The information processing apparatus 1 includes a central processing unit (CPU) 11, a read only memory (ROM) 12, a random access memory (RAM) 13, an auxiliary storage device 14, a network interface 15 for performing communication with the outside via the network, an input device 16, and an output device 17, which are electrically connected with each other. In a specific hardware configuration of the information processing apparatus 1, a constituent element may be omitted, substituted, or added as appropriate in accordance with an embodiment.

The CPU 11 is a central processing unit. The CPU 11 controls the constituent elements, such as the RAM 13 and the auxiliary storage device 14, included in the information processing apparatus 1 by processing commands and data expanded in the ROM 12, the RAM 13, or the like. The RAM 13 is a main memory device. The RAM 13 is controlled by the CPU 11, and various commands and data are written in and read from the RAM 13. Namely, the CPU 11, the ROM 12, and the RAM 13 constitute a control unit 10 of the information processing apparatus 1.

The auxiliary storage device 14 is a nonvolatile storage device. Information that needs to be held even after the power of the information processing apparatus 1 is turned off is mainly written in and read from the auxiliary storage device 14. For example, an operating system (OS) of the information processing apparatus 1 loaded in the RAM 13, various programs for executing processing which will be described below, and various data used by the information processing apparatus 1 are written in and read from the auxiliary storage device 14. For example, an electrically erasable programmable ROM (EEPROM) or a hard disk drive (HDD) can be used as the auxiliary storage device 14. Alternatively, a portable medium detachably attached to the information processing apparatus 1 may be used as the auxiliary storage device 14. Examples of the portable medium include a card/cartridge type medium including a ROM or the like, a compact disc (CD), a digital versatile disc (DVD), and a Blu-ray (registered trademark) Disc (BD). A combination of an auxiliary storage device 14 constituted by a portable medium and a non-portable auxiliary storage device 14 can also be used.

Any of various devices such as a button, a stick, a key board, an acceleration sensor, an angular velocity sensor, or a touch sensor can be adopted as the input device 16. In addition, the input device 16 and the output device 17 which displays an image may be provided together by adopting a touch panel-equipped display.

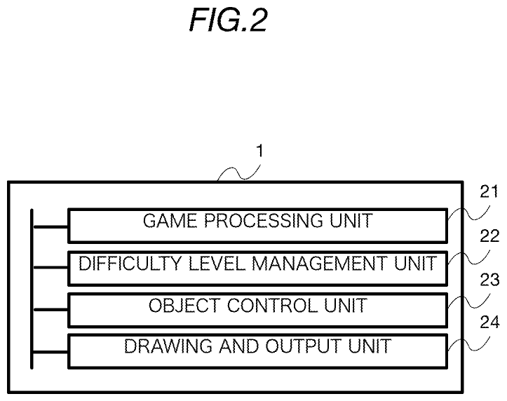

FIG. 2 schematically illustrates a functional configuration of the information processing apparatus 1 according to the present embodiment. The information processing apparatus 1 according to the present embodiment functions as an information processing apparatus including a game processing unit 21, a difficulty level management unit 22, an object control unit 23, and a drawing and output unit 24 by causing the CPU 11 to interpret and execute various programs expanded in the ROM 12, the RAM 13, etc. In the present embodiment, an example in which these functions are performed by the general-purpose CPU 11 will be descried. However, a part or all of these functions may be realized by a single or a plurality of dedicated processors. In addition, the functional units included in the information processing apparatus 1 may be implemented, for example, on a cloud, a server, or the like. In addition, these functional units may be realized by a plurality of software modules, not by a single software module.

The game processing unit 21 processes a game including movement of a player character in a virtual field in accordance with an instruction content corresponding to a user operation via the input device 16. In the virtual field of the game according to the present embodiment, a plurality of areas are set. Various methods could be set as a method for setting the plurality of areas. For example, the plurality of areas may be set by partitioning the virtual field with boundary lines, or a predetermined range based on a reference point set in the virtual field may be set as an individual area.

The difficulty level management unit 22 manages a difficulty level of game play by the user in each of the plurality of areas. In the present embodiment, at least a part of the difficulty level of the game is managed based on an alert level set for each of the plurality of areas. In the present embodiment, the alert level is an index indicating a degree of attention (alert) paid to an action of the player character, etc. in the individual area by an enemy object (an enemy character and other objects including enemy equipment, a trap, etc.) which opposes the player character (namely, interferes with an action and movement of the player character). The alert level is represented by values or ranks. In the present embodiment, as will be described below, the enemy object moves between the areas in accordance with a relationship between the alert levels set for the respective areas.

In addition, upon a predetermined event in accordance with a user operation occurs in the virtual field, the difficulty level management unit 22 lowers the difficulty level (alert level) set for a peripheral area near an event occurrence area including an occurrence point of the predetermined event in the plurality of areas. In addition, the difficulty level management unit 22 heightens the difficulty level (alert level) set for the event occurrence area. The present embodiment describes an example case in which, when the predetermined event occurs, a single event occurrence area is set in the virtual field. However, the number of event occurrence areas set in accordance with the event is not limited. If the event can be generated in a plurality of areas at the same time, a plurality of event occurrence areas may be set in accordance with such event. If the event is generated in a single area, a plurality of areas including this area may also be set as event occurrence areas.

In the present embodiment, an “adjacent area” which is adjacent to a target area in the virtual field is referred to as a “peripheral area”. The “adjacent area” includes an area which shares a boundary line with the target area, an area a part of which overlaps the target area, and an area which has no other area present between this area and the target area (an area reachable without passing through another area), etc. However, the “peripheral area” is not limited to the “adjacent area”. For example, the “peripheral area” may also be defined as an area which exists within a range of a predetermined distance from a certain area or a certain point, an area which can be reached within a predetermined moving cost, etc.

The object control unit 23 controls the enemy object. The enemy object is an object located in the virtual field to oppose the player character. In the present embodiment, the object control unit 23 moves the enemy object from a current area at which the enemy object is currently located to a neighboring area in which the difficulty level (alert level) thereof is set higher than that of the current area. In addition, the object control unit 23 may newly generate the enemy object in an area in which the alert level thereof is heightened or eliminate the enemy object from an area in which the alert level thereof is lowered.

The drawing and output unit 24 draws a result of game processing by the game processing unit 21 and outputs the drawing to the user via the output device 17. The drawing and output unit 24 includes a plurality of drawing units for drawing various game processing results, such as a field drawing unit and a map drawing unit.

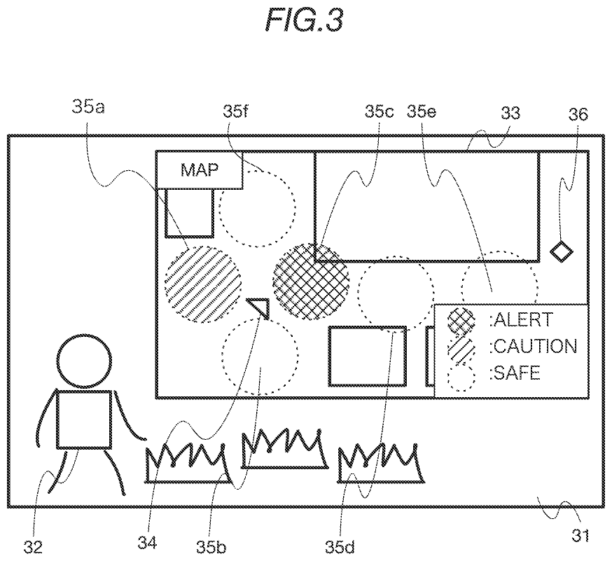

FIG. 3 schematically illustrates a game screen displayed on a display area of the output device 17 according to the present embodiment. A virtual field image 31 on which the game is played is displayed on the display area of the output device 17 as a drawing result by the field drawing unit. The virtual field image 31 includes an image of a character object 32 and images of other objects in a field. The field drawing unit draws character objects of characters including the player character 32 located in a field and other objects (including the enemy object) located in the field from a perspective of a virtual camera arranged in a three-dimensional virtual space including the virtual field. The technique according to the present disclosure is applicable not only to a game including movement in the three-dimensional virtual space. For example, the technique according to the present disclosure is also applicable to a game including movement in a two-dimensional virtual world.

In addition, in the game according to the present embodiment, in accordance with a map display operation by the user, a map image 33 which is a drawing result by the map drawing unit is invoked and displayed in a superimposed manner on the virtual field image 31. The map image 33 includes images representing an overview of the virtual field, a current location 34 of the player character in the field, a destination 36 of the player character, respective locations of a plurality of areas 35a to 35f in the virtual field, a display of respective difficulty levels (alert levels) set for the plurality of areas 35a to 35f, etc.

In the present embodiment, the respective alert levels set for the areas 35a to 35f are notified to the user by applying a corresponding color indicating the degree of the alert level to each circle represented by a dashed line to indicate the individual area in the map image (each circle conceptually indicates the approximate location and size of the individual area and does not necessarily match the actual size or shape of the corresponding area set in the virtual field). Specifically, the circle indicating the area for which the highest alert level (“ALERT rank” in the present embodiment) is set is represented by red, the circle indicating the area for which the second highest alert level (“CAUTION rank” in the present embodiment) is set is represented by orange, and the circle indicating the area for which the lowest alert level (“SAFE rank” in the present embodiment) is set is represented by blue. However, the method for notifying the user of the alert level may be decided as appropriate in accordance with an embodiment, namely, the method is not limited to the example in the present disclosure. For example, the user may be notified of the alert level by using a value or a word (for example, “ALERT”, “CAUTION”, “SAFE”, etc.) given to the area in the map image. In addition, the method for displaying the areas is not limited to the display method using the circles described in the example in the present embodiment. For example, the areas in the field may be defined by boundary lines and displayed on the map.

In addition, the ranks of the alert levels may simply be determined based on predetermined ranges of values of the alert levels (for example, by a determination method in which, if the alert level is indicated by a value between or equal to 0 and 99, the value 80 or more is represented as “ALERT”, the value 60 or more and less than 80 is represented as “CAUTION”, and the value less than 60 is represented as “SAFE”) or may relatively be determined by comparing the alert levels set for a plurality of areas related to each other.

The example illustrated in FIG. 3 indicates that, among the areas 35c to 35e through which the player character operated by the user wants to pass to reach the destination 36 from the current location 34 of the player character, the area 35c has a higher alert level (the ALERT rank). In such the case, the game according to the present embodiment provides the user with means that lowers the alert level of the area 35c by generating an event that attracts the attention of the enemy character, etc. in any of the areas 35a, 35b, 35d, and 35f which are located adjacent to the area 35c.

Processing Flow

Next, a flow of processing performed in the present embodiment will be described. Specific contents of the processing and a processing sequence illustrated in a flowchart according to an embodiment are merely an example for implementing the present disclosure. The specific processing contents and the processing sequence can be suitably selected in accordance with an embodiment of the present disclosure.

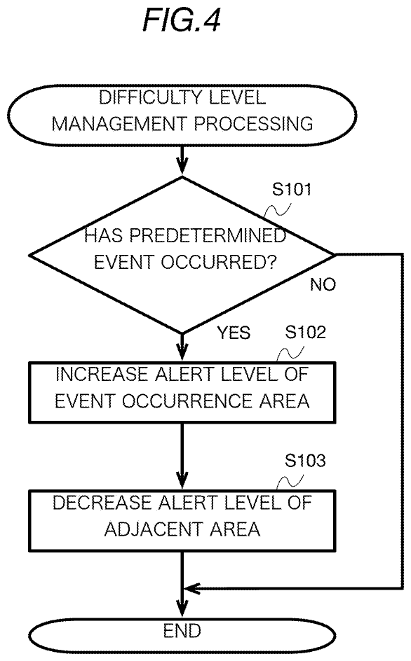

FIG. 4 is a flowchart illustrating a flow of difficulty level management processing according to the first embodiment. Triggered by an instruction to start game processing, the processing illustrated in the present flowchart is repeatedly performed by the information processing apparatus 1 in parallel with the game processing.

In step S101, occurrence of a predetermined event is detected. The difficulty level management unit 22 determines whether the predetermined event attributed to a game operation by the user has occurred in the virtual field. The predetermined event herein is a type of event that can attract an attention of the enemy character, etc. in the game. Examples of such event include creating an explosion, making a loud noise, starting a battle against the enemy character, being found by the enemy character, etc. However, the contents of the predetermined event are not limited to the examples in the present disclosure. If the difficulty level management unit 22 determines that the predetermined event has not occurred, the processing illustrated in the present flowchart ends. If the difficulty level management unit 22 determines that the predetermined event has occurred, the processing proceeds to step S102.

In steps S102 and S103, an alert level is changed. The difficulty level management unit 22 specifies an area (an event occurrence area) where the event detected in step S101 has occurred and heightens the alert level of the event occurrence area (step S102). In addition, the difficulty level management unit 22 specifies all peripheral areas (in the present embodiment, the adjacent areas) around the event occurrence area and lowers each of the alert levels of one or more adjacent areas specified (step S103).

A heightening/lowering range of the alert level may be determined by various methods in accordance with an embodiment. For example, the heightening/lowering range of the alert level can be a predetermined fixed value set for each of the types of the event detected. In this way, the heightening/lowering range of the alert level for the event with greater significance, such as an explosion or a battle, can be set large, and the heightening/lowering range of the alert level for the event with minor significance, such as simply a noise being heard, can be set small. This allows the user to select a game approach method from a wider range of choices. When the alert level has been changed, the processing illustrated in the present flowchart ends.

In addition, the alert level that has been changed may be returned to the original alert level as time elapses. For example, after the alert level has been changed by performing steps S102 and S103, the difficulty level management unit 22 changes the alert level of the area where the alert level has been changed back toward the value (the initial value) before the change as time elapses. Specifically, the difficulty level management unit 22 returns the alert level of each area in which the alert level thereof has been changed to the value before the change by lowering or heightening the changed alert level by a predetermined amount at predetermined time intervals. By performing the above processing, the alert level that has been changed in accordance with the event caused by the user is returned to the original value (rank) as time elapses.

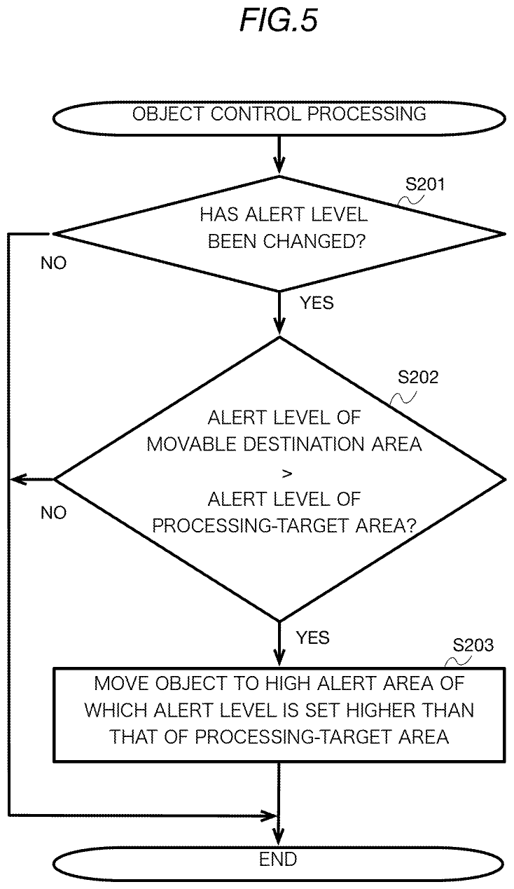

FIG. 5 is a flowchart illustrating a flow of object control processing according to the first embodiment. Triggered by an instruction to start game processing, the processing illustrated in the present flowchart is repeatedly performed by the information processing apparatus 1 on each processing-target area in parallel with the above-described difficulty level management processing.

In step S201, whether any alert level has been changed is determined. The object control unit 23 determines whether the alert level of at least one of the processing-target area and one or more areas (hereinafter, referred to as “movable destination area”) to which the enemy object can be moved from the processing-target area has been changed since a previous check. If the object control unit 23 determines that none of the alert levels of the areas have been changed, the processing illustrated in the present flowchart ends. If the object control unit 23 determines that any of the alert levels of the areas has been changed, the processing proceeds to step S202.

In step S202, whether any high alert area is present is determined. The object control unit 23 compares the alert level of the processing-target area to each of the alert levels of one or more movable destination areas. As a result of the comparison, if none of the movable destination areas includes an area (hereinafter, referred to as “high alert area”) in which the alert level thereof is set higher than that of the processing-target area, the processing illustrated in the present flowchart ends. If the high alert area is found, the processing proceeds to step S203.

In step S203, the object is moved. The object control unit 23 moves at lease a part of enemy objects in the processing-target area to the high alert area found in step S202. A specific moving method may be adopted as appropriate in accordance with an embodiment. For example, the object may be moved in accordance with a pre-set movement path or a path calculated by processing the terrain of the virtual field by using AI (artificial intelligence) or the like after the destination is decided. In addition, the destination of the object may be set anywhere within the high alert area, and the object control unit 23 may move the object to a predetermined point in the high alert area or to a point near the occurrence point of the event caused by the user. When the object has been moved, the processing illustrated in the present flowchart ends.

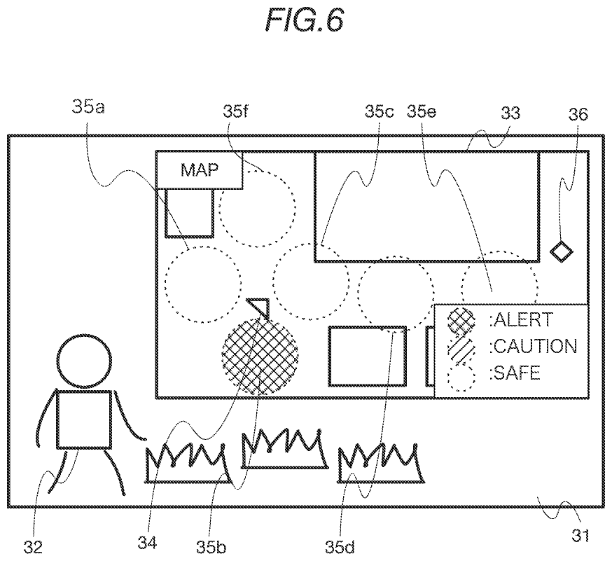

FIG. 6 schematically illustrates a game screen in a case where the difficulty level of each area has been changed in accordance with an event that has occurred according to the present embodiment. A map screen illustrated in FIG. 6 represents a state in which, as a result that the user has generated the event by operating the player character in the virtual field illustrated in FIG. 3, the alert levels of the respective areas have been changed.

Specifically, if the player character generates a predetermined event (for example, exploding a bomb) in the area 35b in a state where the alert levels illustrated in FIG. 3 are set, the alert level of the area 35b is heightened, and in conjunction with this heightening of the alert level, the respective alert levels of the areas 35a and 35c, which are adjacent to the area 35b, are lowered. The example illustrated in FIG. 6 shows that the alert level rank of the area 35b, which was in the SAFE rank before the occurrence of the event, has been heightened to the ALERT rank. In contrast, the alert level ranks of the areas 35c and 35a, which were in the ALERT rank and the CAUTION rank, respectively, before the occurrence of the event, have both been lowered to the SAFE rank. As a result, the player character can safely pass through the area 35c in which the difficulty level thereof has been lowered and reach the destination 36.

Namely, according to the system of the present embodiment, since the difficulty level management processing and the object control processing, which have been described with reference to FIGS. 4 and 5, are performed, upon the user generates a predetermined event, the alert level of the area including the point where the event has occurred is heightened and the number of the enemy objects therein is increased. In addition, the alert level of the peripheral area of the event occurrence area is lowered and the number of the enemy objects therein is decreased. In other words, in the game according to the present embodiment, the user can lower the difficulty level of a desired area by intentionally generating an event.

### Second Embodiment

As the relationship between the alert level and movement of the enemy object, the first embodiment described above adopts a causal relationship in which the enemy object moves in accordance with the alert level set for each area. However, the relationship between the alert level and the movement of the enemy object is not limited to the example described in the first embodiment, and a different relationship may be adopted. For example, heightening and lowering the difficulty level performed by the difficulty level management unit 22 and the object control performed by the object control unit 23 may be processed independently from each other triggered by occurrence of the event.

As a relationship between the alert level and movement of the enemy object, a second embodiment described below adopts a relationship in which the enemy object moves corresponding to occurrence of an event and the alert level is calculated based on the number and the strength, etc. of the enemy object in an area. Namely, the second embodiment adopts a causal relationship in which the alert level varies in accordance with a movement result of the enemy object.

Since a configuration of an information processing system according to the present embodiment is approximately the same as that of the first embodiment described with reference to FIG. 1, descriptions thereof will be omitted. In addition, an information processing apparatus includes a game processing unit 21, a difficulty level management unit 22, an object control unit 23, and a drawing and output unit 24, which is the same configuration as that of the information processing apparatus described in the first embodiment with reference to FIG. 2. However, in the present embodiment, contents of processing performed by the difficulty level management unit 22 and the object control unit 23 differ from those described in the first embodiment.

In the second embodiment, upon a predetermined event occurs, the difficulty level management unit 22 causes the object control unit 23 to move the enemy object from a peripheral area of an event occurrence area to the event occurrence area. Namely, in the second embodiment, the difficulty level management unit 22 lowers a difficulty level (an alert level) set for the peripheral area of the event occurrence area by instructing the object control unit 23 to move the enemy object.

In the second embodiment, upon receiving the instruction from the difficulty level management unit 22, the object control unit 23 moves the enemy object from the peripheral area of the event occurrence area to the event occurrence area.

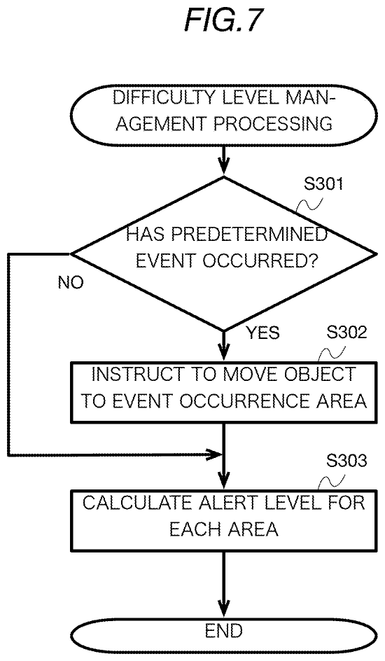

FIG. 7 is a flowchart illustrating a flow of difficulty level management processing according to the second embodiment. Triggered by an instruction to start game processing, the processing illustrated in the present flowchart is repeatedly performed by the information processing apparatus 1 in parallel with the game processing.

In step S301, occurrence of a predetermined event is detected. The difficulty level management unit 22 determines whether the predetermined event (refer to the first embodiment for details) attributed to a game operation by a user has occurred in a virtual field. If the difficulty level management unit 22 determines that the predetermined event has not occurred, the processing proceeds to step S303. If the difficulty level management unit 22 determines that the predetermined event has occurred, the processing proceeds to step S302.

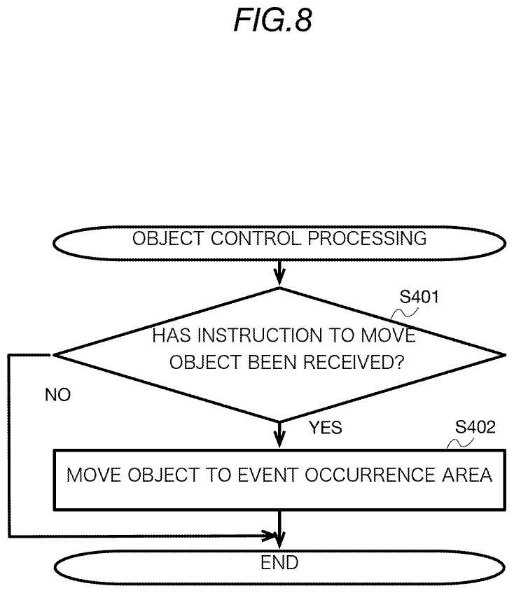

In step S302, an instruction to move the enemy object is issued. If the difficulty level management unit 22 determines that the predetermined event has occurred in step S301, the difficulty level management unit 22 instructs the object control unit 23 to move the enemy object to an event occurrence area. Contents of processing performed by the object control unit 23 that has received the instruction will be described below with reference to FIG. 8. Next, the processing proceeds to step S303.

In step S303, an alert level for each area is calculated. The difficulty level management unit 22 calculates the alert level (the difficulty level) for each area on the basis of the number and strength, etc. of the enemy objects present in each area. Various methods may be adopted to calculate the alert level. For example, the alert level may be calculated by simply counting the number of the enemy objects in each area or by summing up scores of the strength (difficulty level) set for the individual enemy objects in each area. Namely, in the present embodiment, by repeatedly performing the processing in step S303 during the game processing, the alert level reflecting the state of the enemy objects in each area is calculated. When the alert level has been calculated, the processing illustrated in the present flowchart ends.

FIG. 8 is a flowchart illustrating a flow of object control processing according to the second embodiment. Triggered by an instruction to start game processing, the processing illustrated in the present flowchart is repeatedly performed on each processing-target area by the information processing apparatus 1 in parallel with the above-described difficulty level management processing.

In steps S401 and S402, the object is moved in accordance with the instruction from the difficulty level management unit 22. If the object control unit 23 has received the instruction issued in step S302 of the difficulty level management processing (YES in step S401), the object control unit 23 moves at least a part of the enemy objects movable to an event occurrence area in which the predetermined event is determined to have occurred in step S301 to the event occurrence area (step S402). Since a specific method for moving the object is approximately the same as that described in the first embodiment, descriptions thereof will be omitted. When the object has been moved, the processing illustrated in the present flowchart ends.

In addition, the moved enemy object may be returned to the area (the initial area of the enemy object) where the enemy object was located before moving to the event occurrence area when the event that has occurred ends or in accordance with the elapse of time. In a case where the elapse of time is counted, for example, the counting can be started at the timing when the event occurs, when the enemy object starts moving, when the enemy object finishes moving, when the event ends, etc.

Other Variations

In the examples in the embodiments described above, the alert level represents the difficulty level set for each area in the virtual field. However, an index different from the alert level may represent the difficulty level set for each area. For example, the strength of the enemy object, the level of an item given to the player character, the difficulty of a task given to the user, the complexity of a user operation, the degree of a user assistance by the system, etc. in each area may be set as an index of the difficulty level thereof.

In addition, in the embodiments described above, the difficulty level of the area adjacent to the high alert area is lowered by moving the enemy object between the areas. However, the change of the difficulty level of each area may be realized by a method other than the method using the movement of the object between the areas. For example, the difficulty level management unit 22 and the object control unit 23 could heighten the difficulty level of the high alert area by newly generating the enemy object or strengthening the enemy object and lower the difficulty level of the peripheral area by eliminating the enemy object or weakening the enemy object.

What is claimed is:

1. A non-transitory computer-readable recording medium having recorded thereon a game processing program that causes a computer to function as:
a game processing unit that processes a game including movement of a player character in a virtual field in which a plurality of areas are set, in accordance with a user operation; and
a difficulty level management unit that manages a difficulty level of game play by the user in each of the plurality of areas, wherein upon a predetermined event in accordance with the user operation occurs in the virtual field, the difficulty level management unit lowers the difficulty level set for a peripheral area near an event occurrence area including an occurrence point of the predetermined event among the plurality of areas.

2. The non-transitory computer-readable recording medium having recorded thereon the game processing program according to claim 1, wherein, upon a predetermined event in accordance with the user operation occurs in the virtual field, the difficulty management unit heightens the difficulty level set for the event occurrence area.

3. The non-transitory computer-readable recording medium having recorded thereon the game processing program according to claim 1, wherein
the game processing program causes the computer to further function as an object control unit that controls an object which is located in the virtual field to oppose the player character, and
the object control unit moves the object from a current area at which the object is currently located to a neighboring area in which the difficulty level thereof is set higher than the difficulty level of the current area.

4. The non-transitory computer-readable recording medium having recorded thereon the game processing program according to claim 1, wherein
the game processing program causes the computer to further function as an object control unit that controls an object which is located in the virtual field to oppose the player character, and
upon the predetermined event occurs, the difficulty management unit lowers the difficulty level set for a peripheral area of the event occurrence area by causing the object control unit to move the object from the peripheral area of the event occurrence area to the event occurrence area.

5. The non-transitory computer-readable recording medium having recorded thereon the game processing program according to claim 1, wherein the game processing program causes the computer to further function as a map drawing unit that draws a map including an overview of the virtual field, locations of the plurality of areas in the virtual field, and a display of the difficulty level set for each of the plurality of areas.

6. An information processing apparatus, comprising:
a game processing unit that processes a game including movement of a player character in a virtual field in which a plurality of areas are set in accordance with a user operation; and
a difficulty level management unit that manages a difficulty level of game play by the user in each of the plurality of areas, wherein
upon a predetermined event in accordance with the user operation occurs in the virtual field, the difficulty level management unit lowers the difficulty level set for a peripheral area near an event occurrence area including an occurrence point of the predetermined event among the plurality of areas.

7. A game processing method for causing a computer to execute steps of:
processing a game including movement of a player character in a virtual field in which a plurality of areas are set in accordance with a user operation; and
managing a difficulty level of game play by the user in each of the plurality of areas, wherein
upon a predetermined event in accordance with the user operation occurs in the virtual field, the step of managing the difficulty level lowers the difficulty level set for a peripheral area near an event occurrence area including an occurrence point of the predetermined event among the plurality of areas.
